(19) United States
(12) Patent Application Publication
(10) Pub. No.: US 2024/0187345 A1
(43) Pub. Date: Jun. 6, 2024

(54) METHOD AND SYSTEM FPOR TRANSFERRING DATA TO IMPROVE RESPONSIVENESS WHEN SENDING LARGE DATA SETS

(71) Applicant: PME IP PTY LTD., Richmond (AU)

(72) Inventors: Detlev Stalling, Berlin (DE); Malte Westerhoff, Berlin (DE)

(73) Assignee: PME IP PTY LTD., Richmond (AU)

(21) Appl. No.: 18/439,729

(22) Filed: Feb. 12, 2024

Related U.S. Application Data
(63) Continuation of application No. 17/694,345, filed on Mar. 14, 2022, now Pat. No. 11,916,794.
Application No. 17/694,345 is a continuation of application No. 16/986,000, filed on Aug. 5, 2020, now Pat. No. 11,296,989.
Application No. 16/986,000 is a continuation of application No. 16/403,219, filed on May 3, 2019, now Pat. No. 10,764,190.
Application No. 16/403,219 is a continuation of application No. 15/652,164, filed on Jul. 17, 2017, now Pat. No. 10,320,684.
Application No. 15/652,164 is a continuation of application No. 15/361,038, filed on Nov. 24, 2016, now Pat. No. 9,749,245.
Application No. 15/361,038 is a continuation of application No. 13/831,982, filed on Mar. 15, 2013, now Pat. No. 9,509,802.

(51) Int. Cl. H04L 47/127; H04L 43/0894; H04L 45/121; H04L 45/125; H04L 47/10; H04L 47/12; H04L 47/27; H04L 67/01; H04L 69/04; H04L 69/163

(52) U.S. Cl. CPC H04L 47/127; H04L 43/0894; H04L 47/10; H04L 47/12; H04L 47/27; H04L 67/01; H04L 69/04; H04L 69/163; H04L 45/121; H04L 45/125

(57) ABSTRACT

Most of the internet traffic today is carried out via the Transmission Control Protocol (TCP). The main advantage of TCP is that it provides reliable data transfer to the application layer and simplifies programming. The protocol maximizes data throughput but may also lead to noticeable transmission delay in wide area networks (WAN). A client-server based medical image viewing system is disclosed that achieves high data throughput over TCP without impacting responsiveness. Special timestamp messages inserted into the data stream allow the system to detect situations where network latency increases noticeably and to obtain a reliable estimate of sustained transfer bandwidth. The system applies a feedback scheme that avoids network delays by limiting send bandwidth. In addition other parameters, in particular image compression settings, are dynamically adjusted depending on current network quality.

### PRIORITY CLAIM

This application is a continuation of (1) U.S. application Ser. No. 17/694,345 entitled ‘METHOD AND SYSTEM FOR TRANSFERRING DATA TO IMPROVE RESPONSIVENESS WHEN SENDING LARGE DATA SETS’, inventors D Stalling et al., filed Mar. 14, 2022, which is a continuation of (2) U.S. application Ser. No. 16/986,000 entitled ‘METHOD AND SYSTEM FOR TRANSFERRING DATA TO IMPROVE RESPONSIVENESS WHEN SENDING LARGE DATA SETS’, inventors D Stalling et al., filed Aug. 5, 2020 which issued Dec. 27, 2021 as U.S. Pat. No. 11,296,989 which is a continuation of (3) U.S. application Ser. No. 16/403,219 entitled ‘METHOD AND SYSTEM FOR TRANSFERRING DATA TO IMPROVE RESPONSIVENESS WHEN SENDING LARGE DATA SETS’, inventors D Stalling et al., filed May 3, 2019 which issued Sep. 1, 2020 as U.S. Pat. No. 10,764,190 which is a continuation of (4) U.S. application Ser. No. 15/652,164 entitled ‘METHOD AND SYSTEM FOR TRANSFERRING DATA TO IMPROVE RESPONSIVENESS WHEN SENDING LARGE DATA SETS’, inventors D Stalling et al., filed Jul. 17, 2017 which issued Jun. 11, 2019 as U.S. Pat. No. 10,320,684 which is a continuation of and claims priority to (5) U.S. application Ser. No. 15/361,038 entitled ‘METHOD AND SYSTEM FOR TRANSFERRING DATA TO IMPROVE RESPONSIVENESS WHEN SENDING LARGE DATA SETS’, inventors D Stalling et al., filed Nov. 24, 2016 which issued Aug. 29, 2017 as U.S. Pat. No. 9,749,245 which is a continuation of and claims priority to (6) U.S. application Ser. No. 13/831,982 entitled ‘METHOD AND SYSTEM FOR TRANSFERRING DATA TO IMPROVE RESPONSIVENESS WHEN SENDING LARGE DATA SETS’, inventors D Stalling et al., filed Mar. 15, 2013 which issued Nov. 29, 2016 as U.S. Pat. No. 9,509,802, the teachings of (1) to (6) are explicitly incorporated herein by reference in their entireties and for all purposes.

### FIELD OF INVENTION

The invention pertains to digital data processing and, more particularly, by way of example, to the transferring of data between a client and a server and has application to areas including medical imaging, atmospheric studies, astrophysics, microscopy, spectroscopy, satellite imaging and geophysics.

### BACKGROUND

Many computer applications today demand high network bandwidth over the internet. Good examples are systems that download large amount of data such as files, music or videos. Most of the internet traffic today is carried out via the Transmission Control Protocol (TCP). The main advantage of TCP is that it provides reliable data transfer to the application layer. The application does not have to deal with lost data packets, corrupted data packets, or out-of-order arrival of packets. All types of error detection and retransmission algorithms are already implemented in the TCP protocol. Also, sophisticated methods for congestion avoidance and flow control have been added to the TCP protocol. Most of these methods are intended to optimize bandwidth, i.c., data throughput, over a network.

Maximized data throughput usually comes at the price of increased latency. For example, a common technique is to not send out small pieces of data immediately but to wait until more data is available, so that larger packets can be sent then (e.g. Nagle algorithm). This increases bandwidth but also introduces extra delay. Another approach is to send out large amounts of data before getting an acknowledgement by the receiver. This also increases bandwidth but at the same time may increase the time a data packet is in transfer.

For many applications maximum bandwidth is by far the most important criterion. Increased latency is often not a problem. This is not true for applications like voice over Internet Protocol (IP) or teleconferencing. Here low response times, i.e. low latency, are crucial. These applications usually disable the Nagle algorithm or do not use TCP at all. Often bandwidth requirements are not that high for such applications.

Another class of applications requires both high bandwidth and low latency. This is true for example for a client-server based medical image viewer. Such a system needs to display large amounts of image data which are streamed from the server to the client. Often it is advisable to send images before they are requested by the client such as in traditional streaming applications. For example, if a doctor looks at the first image of a 3D image series then it is likely that she will also look at the second image soon. But if the doctor proceeds, some images that are scheduled for later streaming suddenly have to be transferred immediately, or images have to be rendered on the server and then displayed on the client as soon as possible. Thus it is important that the server stays always responsive and that new data can be sent as quickly as possible to the client based on current user interaction.

A general aspect of network based applications is that often not all parameters of the network are known, or can be influenced by the application. For example routers or other network devices between the endpoints may introduce latencies and buffers that are not application controlled. Often the network has to be regarded a black box.

### SUMMARY OF THE INVENTION

In an embodiment of the present invention, a client-server based medical image viewing system that sends data over a standard TCP connection in such a way that high data throughput is achieved without impacting responsiveness. Special timestamp messages inserted into the data stream allow the system to detect situations where network latency increases noticeably and to obtain a reliable estimate of sustained transfer bandwidth. In an embodiment of the present invention, the system applies a feedback scheme that avoids network delays by limiting send bandwidth. In various embodiments of the present invention, other parameters, in particular image compression settings, can be dynamically adjusted depending on current network latency.

### BRIEF DESCRIPTION OF THE DRAWINGS

FIG. 1 is a diagram showing a simple network model with filled buffer;

FIG. 2 is a diagram showing a simple network model with empty buffer; and

FIG. 3 is flowchart showing an overview of transferring timestamp messages and other data between the client and server.

### DESCRIPTION OF THE INVENTION

### Definitions

The transitional term “comprising” is synonymous with “including,” “containing,” or “characterized by,” is inclusive or open-ended and does not exclude additional, unrecited elements or method steps.

The transitional phrase “consisting of” excludes any element, step, or ingredient not specified in the claim, but does not exclude additional components or steps that are unrelated to the invention such as impurities ordinarily associated with a composition.

The transitional phrase “consisting essentially of” limits the scope of a claim to the specified materials or steps and those that do not materially affect the basic and novel characteristic(s) of the claimed invention.

The term “bandwidth” and “send bandwidth” refer to various bit-rate measures, representing the available or consumed data communication resources expressed in bits per second or multiples of it.

The term “adaptive bandwidth management” means methods that continuously adjust the amount of data that is sent into a network per time in order to avoid or reduce network congestion and transfer delay . . .

The term “buffer” or “network buffer” refers to a temporary storage area acting as a holding area, enabling the computer or network to manipulate data before transferring it to a device.

The term “client-server” refers to a computer system that selectively shares its resources; a client is a computer or computer program that initiates contact with a server in order to make use of a resource. This sharing of computer resources allows multiple people to use a computer server at the same time. Because a computer does a limited amount of work at any moment, a time-sharing system must quickly prioritize its tasks to accommodate the clients. Clients and servers exchange messages in a request-response messaging pattern: The client sends a request, and the server returns a response.

The term “application layer” or “application-level protocol” refers to the communications between computers. To communicate, the computers must have a common language, and they must follow rules so that both the client and the server know what to expect. The language and rules of communication are defined in a communications protocol. All client-server protocols operate in the application layer.

The term “lossy compression” refers to a data encoding method that compresses data by discarding or losing some of it. The procedure aims to minimize the amount of data that needs to be held, handled, and/or transmitted by a computer.

The term “network latency” can be measured either ‘one-way’ as the time taken for the source to send a packet to a destination or ‘round-trip’ from the one-way latency from source to destination plus the one-way latency from the destination back to the source.

The term “pseudo code” is an informal high-level description of the operating principle of a computer program or other algorithm.

The term “timestamp message” refers to a message that contains an indication of a point in time on either the server or the client, or the difference between two such points in time. Timestamp messages may be exchanged between client and server in both directions.

The term “Transmission Control Protocol” or TCP includes using a “congestion window” to determine how many packets can be sent at one time. The larger the congestion window size, the higher the throughput. The TCP “slow start” and “congestion avoidance” algorithms determine the size of the congestion window. The maximum congestion window is related to the amount of buffer space that the kernel allocates for each socket.

In the following description, various aspects of the present invention will be described. However, it will be apparent to those skilled in the art that the present invention may be practiced with only some or all aspects of the present invention. For purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in data processing terms, such as data, selection, retrieval, generation, and so forth, consistent with the manner commonly employed by those skilled in the art to convey the substance of their work to others skilled in the art. As is well understood by those skilled in the art, these quantities (data, selection, retrieval, generation) take the form of electrical, magnetic, or optical signals capable of being stored, transferred, combined, and otherwise manipulated through electrical, optical, and/or biological components of a processor and its subsystems.

Various operations will be described as multiple discrete steps in turn, in a manner that is most helpful in understanding the present invention; however, the order of description should not be construed as to imply that these operations are necessarily order dependent.

Various embodiments will be illustrated in terms of exemplary classes and/or objects in an object-oriented programming paradigm. It will be apparent to one skilled in the art that the present invention can be practiced using any number of different classes/objects, not merely those included here for illustrative purposes. Furthermore, it will also be apparent that the present invention is not limited to any particular software programming language or programming paradigm.

The invention is illustrated by way of example and not by way of limitation in the figures of the accompanying drawings in which like references indicate similar elements. It should be noted that references to ‘an’ or ‘one’ embodiment in this disclosure are not necessarily to the same embodiment, and such references mean at least one.

A render server program is described in U.S. application Ser. No. 13/831,967, entitled “Multi-User Mult-GPU Render Server Apparatus and Methods”, inventors M. Westerhoff etr al, which was filed Mar. 15, 2013, is herein expressly incorporated by reference in its entirety. A rule based render server program is described in U.S. application Ser. No. 13/831,975, entitled “Method and System for Rule-Based Display of Sets of Images”, inventors M. Westerhoff et al, which was filed Mar. 15, 2013, is herein expressly incorporated by reference in its entirety.

In one embodiment of the present invention, a client-server based medical image viewing system uses the TCP protocol for data transfer, but at the same time avoids network congestion and thus achieves both high data throughput and low latency. The system is non-intrusive in that it does not change the TCP implementation and does not make use of special network drivers. Instead, the transport layer is considered as a black box and only the actual performance of the network is monitored. Based on the monitoring results different actions are taken by the application itself in order to cope with the current network quality.

### Water Pipe Model

The following analogy helps to illustrate an embodiment of the present invention. Assume that a network behaves like a system of water pipes of different cross-sections. Somewhere inside the system there are “water barrels” or network buffers that can fill up as shown in FIG. 1. Initially a large amount of “water” or data can be pumped into the network. “Inflow” or send bandwidth is high 120, but “outflow” or “read bandwidth” on the client side might be much smaller 130. In effect the “water barrels” or network buffers 100 fill up 110. It then takes a long time until a new “drop of water” or data packet can pass into the network. Latency has increased and the server is not able to respond quickly to user input. The result is that the “pipes” or connections are congested.

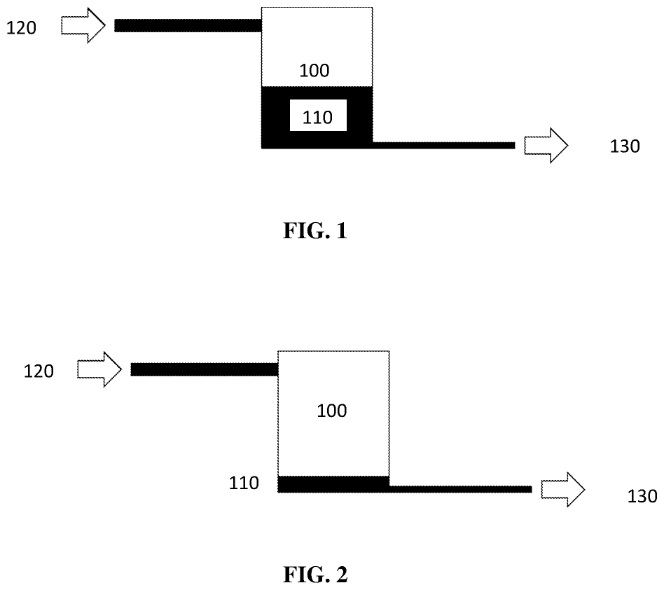

In order to keep the server responsive it is important to prevent the network buffers 100 from filling up 110 as depicted in FIG. 2. In an embodiment of the invention, the server can only send as much data into the network 120 as the thinnest pipe or weakest connection can convey 130. Note, that the overall throughput or bandwidth is not decreased if send bandwidth is limited.

### Detecting Latency Increase

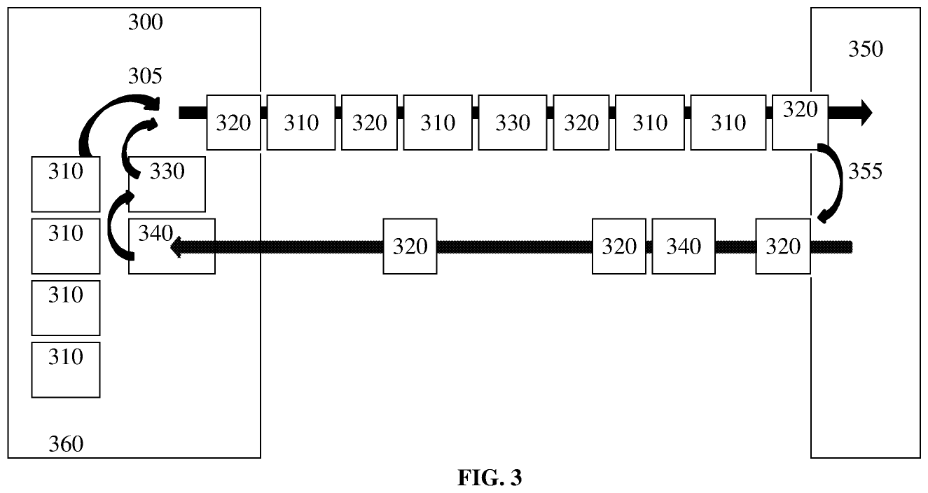

In an embodiment of the present invention, the system uses its own message-based protocol that is transported over a TCP connection. In this embodiment, all benefits of TCP are retained for case of use and reliability. Small timestamp messages are sent from the server to the client and back from the client to the server. FIG. 3 is a flowchart depicting an overview of the message-based protocol and timestamp messages. These timestamp messages allow an estimate of the current network bandwidth to determine when network latency will increase due to congestion or decrease due to de-congestion. In FIG. 3 the server is on the left 300 and the client is on the right 350. The server has a transfer queue 360 that holds multiple data packets 310 queued for transfer. In addition, the client may request 340 extra packets 330 from the server. Data packets requested by the client have precedence 305 over packets originating from the transfer queue. Inserted into the data stream are timestamp messages 320 which are first sent from the server to the client and then returned by the client 355.

A timestamp message that the server sends to the client only contains the time ‘t’ in milliseconds since the server was started. In addition, the server stores the timestamp message in a First In, First Out (FIFO) queue. Together with the message the server also stores the total number of bytes ‘c’ that were sent to the client up to that point in time, as well as the current send bandwidth b_{send} in bytes/sec.

In an embodiment of the present invention, every timestamp message that arrives at the client is immediately sent back to the server. In an embodiment of the present invention, the order of messages is preserved. In an embodiment of the present invention, messages that are sent back to the server contain the difference ‘d’ between the client time (measured in milliseconds since client was started) and the server time ‘t’ that was contained in the incoming timestamp message. In an embodiment of the present invention, it is not required that clocks on server and client are synchronized, i.e., that both clocks were started at the same time.

In an embodiment of the present invention, the smallest value dmin that occurs in any of the timestamp messages that arrive back at the server defines a baseline for detecting increased latency. Without synchronized clocks it is difficult if not impossible to determine how long it really takes for a message to pass from the server to the client. However, it is possible to determine how much more travel time was needed for an arbitrary message compared to the fastest message. This increase of travel time or delay is given by e=d−dₘᵢₙ. If ‘e’ increases significantly it is apparent that network buffers are filling up and that send bandwidth must be reduced.

### Estimating Bandwidth

In an embodiment of the present invention, a key requirement for the system to be able to choose a reasonable send bandwidth and to adjust other application settings to network quality is a reliable estimate of sustained transfer bandwidth. An estimate is computed as follows:

If a timestamp message arrives back at the server, it is taken out of the FIFO queue. The time that was spent on the client between receiving the last two timestamp messages is given by:

T=tᵢ−tᵢ₋₁+dᵢ−dᵢ₋₁

The amount of data C that was read in that time is given by the number of bytes that were sent between the last two timestamp messages:

C=cᵢcᵢ₋₁

From these quantities the read bandwidth at the client is determined as:

b_{read}=C/T.

In an embodiment of the present invention, if send bandwidth b_{send} is significantly larger than read bandwidth b_{read} (e.g. by more than 30%) we assume that the network is saturated and that b_{read} is a good estimate of transfer bandwidth. In an embodiment of the present invention, a running average is computed of multiple (e.g. 10) such b_{read} samples in order to obtain a best estimate bₑₛₜ of transfer bandwidth. In an unexpected result, in order to quickly get reliable results, especially shortly after the client was started and the network is not yet saturated, it turned out to be beneficial to also include b_{read} samples into the running average if they are significantly larger than the current best estimate (e.g. by more than 40%). Further, in an embodiment of the present invention, outliers can be discarded by clamping b_{read} so that it does not exceed twice the current best estimate bₑₛₜ.

### Limiting Send Bandwidth

In an embodiment of the present invention, a good estimate bₑₛₜ of sustained transfer bandwidth allows the transfer to be slowed in case latency increases noticeably. In an embodiment of the present invention, send bandwidth is limited if the delay ‘e’ exceeds a certain threshold eₘₐₓ. In an embodiment of the present invention, send bandwidth is limited when e is greater than approximately 40 msec. In an alternative embodiment of the present invention, send bandwidth is limited when e is greater than approximately 50 msec. When calculating ‘c’ approximately refers to plus or minus twenty percent. In an embodiment of the present invention, a bandwidth limit bₗᵢₘᵢₜ of approximately sixty (60) percent of bₑₛₜ is enforced when ‘c’ exceeds eₘₐₓ. In an alternative embodiment of the present invention, a bandwidth limit bₗᵢₘᵢₜ of approximately seventy (70) percent of bₑₛₜ is enforced when ‘e’ exceeds eₘₐₓ. When calculating ‘b’ approximately refers to plus or minus twenty percent. In an embodiment of the present invention, if delay ‘e’ later drops below eₘₐₓ, the bandwidth limit is gradually lifted again by incrementing the current limit by a value that is increased if extra latency is reduced.

In various embodiments of the present invention, extra safeguards can be incorporated into the scheme in order to make it more robust against measurement errors and noise. In an embodiment of the present invention, bandwidth is not reduced if there are less than 10 KB of data in the line. In an embodiment of the present invention, the number of bytes in the line can be estimated by c−cᵢ, where c is the current total number of bytes that were sent to the client up to that point in time and cᵢ is the total number of bytes that were sent to the client at the time the current timestamp message was sent. In an embodiment of the present invention, if a bandwidth limit is already active it is never reduced by more than 50%.

The resulting feedback scheme leads to a transmission rate on the server side that constantly oscillates around the estimated sustained transfer bandwidth bₑₛₜ. Usually oscillation frequency is higher if the total latency between server and client is lower. This is because timestamp messages return earlier at the server, and thus the server can adjust transmission rate more quickly. On higher latency connections oscillation frequency is lower, and amplitude of latency oscillation is greater. In various embodiments of the present invention, the overall behavior of the feedback scheme can be tuned by varying the different parameters. In practice, the values stated above turned out to work very well for different kinds of networks ranging from metropolitan area networks, domestic connections, and intercontinental lines.

Feedback scheme pseudo code:

```
if (e > eₘₐₓ)
then
  if (number of bytes in line > threshold)
  then
    bₗᵢₘᵢₜ := max (Factor₁ * bₑₛₜ, Factor₂ * bₗᵢₘᵢₜ)
  end
else
if (b_{read} > Factor₃ * bₗᵢₘᵢₜ)
then
  d := Factor₄ * bₗᵢₘᵢₜ * (eₘₐₓ − e) /eₘₐₓ
  bₗᵢₘᵢₜ := bₗᵢₘᵢₜ + d
end
```

### Adjusting Compression Settings and Buffering

In an embodiment of the present invention, the server always stays responsive by limiting send bandwidth. In an embodiment of the present invention, if a large number of data files (e.g., images) are queued for transfer on the server, when the client requests a large data file (e.g., a new image) or some other information be delivered instantly, then this new data can be sent without significant extra delay as seen in FIG. 3.

In an embodiment of the present invention, a good estimate of transfer bandwidth also allows the application to dynamically adjust other settings to current network quality, like image compression settings. If network bandwidth is poor, the application can react to that occurrence. For a single-stream application, such as streaming a single video or audio channel, the compression ratio can simply be adjusted such that the resulting bandwidth is slightly under the available bandwidth, which combined with buffering yields the desired result.

In another embodiment of the present invention, in an interactive visualization application, adjustable lossy compression can be applied in a similar manner in order to achieve smooth interaction. Image quality might be degraded, but images can still be displayed very quickly. Higher quality versions of the images can be resent later and the view can be refined. It is not obvious though, how buffering can be applied, because the interaction is not known ahead of time.

An example for such an application is a client server system to display medical image studies. Medical image studies can consist of multiple images that can be organized in multiple series. It is desirable to be able to view these images in a multi-viewport layout on the client computer. As the user looks at a series of images, the user will interact with the images, e.g., scrolling, rotating panning or zooming. It is not known in advance, in which direction a user will scroll, or if multiple image series exist, which of these the user will look at first. The same is true for any other interaction with the scene, such as rotation of a 3D volume rendering.

Another embodiment of the present invention monitors the current user interaction and allows the application to anticipate the next views to be streamed. These views are then streamed to the client and buffered, so that they can be displayed without delay.

For example if a user looks at and interacts with a viewport displaying one image series (“Current Series”), images from that series will more likely be displayed next than images from other series. Thus these images will be streamed to a buffer on the client side first. The order is determined by the distance of images to the currently displayed image in the sorting order of the series: The closest image will be streamed first. The same concept applies to other types of displays and other types of interaction. For example if a 3D volume rendered view of a data set is shown and the user currently rotates the model about e.g. the X-axis, then from the current view, the next views can be anticipated and pre-streamed and buffered locally.

In another embodiment of the present invention, if the user stops rotating, then some views that may have been buffered already may need to be discarded from the buffer, but that is typically a small number compared to the whole sequence. In order to use these techniques in interactive applications, a high-degree of responsiveness is required to avoid lags when the user decides to change e.g. scrolling or rotation direction or starts interacting with another view port. This responsiveness is achieved by the adaptive bandwidth management as described above.

TABLE 1
Symbols and Meaning

| Symbol | Description |
|---|---|
| T | Server time in msec (since session was started) |
| C | Total number of bytes that were sent from server to client |
| b_{send} | Send bandwidth at server |
| b_{read} | Read bandwidth at client |
| bₑₛₜ | Estimate of sustained transfer bandwidth |
| bₗᵢₘᵢₜ | Bandwidth limit on server side (send) |
| D | Difference between client and server time when TS arrives at |
| | client |
| E | Extra travel time for messages sent from server to client (delay) |

While the present invention has been described in some detail for purposes of clarity and understanding, one skilled in the art will appreciate that various changes in form and detail can be made without departing from the true scope of the invention. All figures, tables, and appendices, as well as patents, applications, and publications, referred to above, are hereby incorporated by reference.

### Aspects of the Invention

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency.

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency, where the estimate of current network bandwidth is calculated from a difference between the first time and the second time or the second time and the subsequent times.

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency, where the estimate of current network bandwidth is compared with a minimum network bandwidth.

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency, where the estimate of current network bandwidth is compared with a minimum network bandwidth, further comprising refining the estimate of current network bandwidth based on a comparison.

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency, where information related to one or more of the first timestamp message and the one or more second timestamp messages is not included in the first timestamp message, where the information is stored in a first in first out queue, so that the information can be evaluated when the first timestamp message arrives back at the server.

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency, where one or more of the first timestamp message and the one or more second timestamp messages are used to compute read bandwidth (C/T), where C=cᵢ−cᵢ₋₁, where C is an amount of data C that was read in a time between a last two timestamp messages (cᵢ, c₋₁), and T=tᵢ−tᵢ₋₁+dᵢ−dᵢ₋₁, where dᵢ and dᵢ₋₁ are client time and tᵢ−tᵢ₋₁ are server time in a last two incoming timestamp messages.

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency, where one or more of the first timestamp message and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−d₋₁, where dᵢ and dᵢ₋₁ are client time and tᵢ−tᵢ₋₁ are server time in a last two incoming timestamp messages, further comprising determining a running average, where samples of read bandwidth are combined into the running average.

In an embodiment of the invention, a method of identifying network latency comprising the steps of sending a request for image data from a client computer, including inserting a first timestamp message into the request for image data at an application level, transferring the request and the first timestamp message to a server using a standard Transmission Communications Protocol (TCP) connection, receiving the first timestamp message at the server, calculating a first time for the first timestamp message to be sent from the client computer to the server, sending one or more second timestamp messages from the server to the client computer, returning the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times and using the estimate of current network bandwidth to determine network latency, where one or more of the first timestamp message and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁, where dᵢ and dᵢ₋₁ are client time and tᵢ−tᵢ₋₁ are server time in a last two incoming timestamp messages, further comprising determining a running average, where samples of read bandwidth are combined into the running average, where samples are excluded from the running average when send bandwidth is less than between a lower limit of approximately 20 percent of read bandwidth and an upper limit of approximately 40 percent of read bandwidth.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where the estimate of current network bandwidth is calculated from a difference between the first time and the second time or the second time and the subsequent times.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where the estimate of current network bandwidth is compared with a minimum network bandwidth.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where the estimate of current network bandwidth is compared with a minimum network bandwidth, further comprising refining the estimate of current network bandwidth based on a comparison between times.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where samples are excluded from the running average when send bandwidth is less than between a lower limit of approximately 130 percent of the read bandwidth measured at a time a timestamp message arrived at the client computer and an upper limit of approximately 140 percent of the estimate of current network bandwidth.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the feedback scheme uses a pseudo code.

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the feedback scheme uses a pseudo code, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the lossy compression rate is calculated in order to achieve a desired interactive speed, where the feedback scheme uses a pseudo code, where the lossy compression rate is used to stream compressed images with a compression ratio, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the lossy compression rate is calculated in order to achieve a desired interactive speed, where the feedback scheme uses a pseudo code, where the lossy compression rate is used to stream compressed images with a compression ratio, where images are streamed to the client computer using a buffering system, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the lossy compression rate is calculated in order to achieve a desired interactive speed, where the feedback scheme uses a pseudo code, where the lossy compression rate is used to stream compressed images with a compression ratio, where images are streamed to the client computer using a buffering system, where the buffering system is based on monitoring user interaction and anticipating a next image that will be requested by the client computer, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the lossy compression rate is calculated in order to achieve a desired interactive speed, where the feedback scheme uses a pseudo code, where the lossy compression rate is used to stream compressed images with a compression ratio, where images are streamed to the client computer using a buffering system, where the buffering system is based on monitoring user interaction and anticipating a next image that will be requested by the client computer, where the bandwidth limit is used to compute the lossy compression rate, where the lossy compression rate is used to calculate a compression ratio, where one or more compressed images are streamed with the compression ratio, where a target compression quality is defined by a user, where a first image is streamed with a first compression quality, where the first compression quality minimizes network latency during interaction based on bandwidth monitoring and where the first image is streamed with a second compression quality when the user stops interacting, where the second compression quality is greater than the first compression quality if the first compression quality is lower than a target compression quality, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the lossy compression rate is calculated in order to achieve a desired interactive speed, where the feedback scheme uses a pseudo code, where the lossy compression rate is used to stream compressed images with a compression ratio, where images are streamed to the client computer using a buffering system, where the buffering system is based on monitoring user interaction and anticipating a next image that will be requested by the client computer, where the bandwidth limit is used to compute the lossy compression rate, where the lossy compression rate is used to calculate a compression ratio, where one or more compressed images are streamed with the compression ratio, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the lossy compression rate is calculated in order to achieve a desired interactive speed, where the feedback scheme uses a pseudo code, where the lossy compression rate is used to stream compressed images with a compression ratio, where images are streamed to the client computer using a buffering system, where the buffering system is based on monitoring user interaction and anticipating a next image that will be requested by the client computer, where the bandwidth limit is used to compute the lossy compression rate, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the lossy compression rate is calculated in order to achieve a desired interactive speed, where the feedback scheme uses a pseudo code, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In an alternative embodiment of the present invention, a method of minimizing network latency comprises the steps of sending a request for image data from a client computer, including inserting one or more first timestamp messages into the request for image data at an application level, transferring the request and the one or more first timestamp messages to a server using a standard Transmission Communications Protocol (TCP) connection, receiving the one or more first timestamp messages at the server, calculating a first time for the one or more first timestamp messages sent from the client computer to the server, sending one or more second timestamp messages from the server to the client computer, sending the one or more second timestamp messages from the client computer to the server, receiving the one or more second timestamp messages from the client computer at the server, calculating a second time and subsequent times taken for the one or more second timestamp messages to be sent from the client computer to the server, calculating an estimate of current network bandwidth based on one or more of the first time, the second time and the subsequent times, determining situations where network latency will otherwise increase due to congestion and using the estimate of current network bandwidth to one or both reduce and modify client computer requests to minimize network latency, where information related to one or both the one or more first timestamp messages and the one or more second timestamp messages is not included in the one or more first timestamp messages and the one or more second timestamp messages, where the information is stored in a first in first out queue, so that the information can be evaluated when the one or more first timestamp messages and the one or more second timestamp messages arrives back at the server, where one or both the one or more first timestamp messages and the one or more second timestamp messages are used to compute read bandwidth (C/T), where C=cᵢ−cᵢ₋₁, where C is an amount of data C that was read in a time between a last two timestamp messages (cᵢ, cᵢ₋₁), and T=tᵢ−tᵢ₋₁+dᵢ−dᵢ₋₁ is the time elapsed on the client computer between the last two timestamp messages, where tᵢ−tᵢ₋₁ is the time elapsed on the server between the last two timestamp messages, and dᵢ and dᵢ₋₁ are differences between client computer time and server time when the messages arrived at the client computer, further comprising determining a running average, where samples of read bandwidth are combined into the running average, where a bandwidth limit is applied on the server in order to avoid network delays, where the bandwidth limit is computed using a feedback scheme, where the bandwidth limit is used to compute a lossy compression rate, where the feedback scheme uses a pseudo code, where the pseudo code includes an expression

```
if (e > emax)
then
  if (number of bytes in line > threshold)
  then
    blimit := max(Factor1 * best, Factor2 * blimit)
  end
else
if (bread > Factor3 * blimit)
then
  d := Factor4 * blimit * (emax − e)/emax
  blimit := blimit + d
end.
```

In another embodiment of the present invention, a display protocol defines multiple viewers, each with one or more tiles, i.e., viewports. To each viewer one or more image sets can be assigned based on Viewer Assignment Rules that are similar to the protocol section rules described herein. Viewer Assignment Rules are defined in the display protocol. The rules determine which image set shall be initially shown in a viewer. In case multiple image sets are assigned to a viewer, the one with the highest score is chosen. Afterwards users may cycle quickly through the remaining image sets using dedicated tools (Previous/Next Image Set), or pick another image set from a special image set menu.

What is claimed:

1. A method of increasing responsiveness of a server operating a TCP connection (Transmission Control Protocol connection) comprising:
A) opening the TCP connection to receive and send TCP data packets at the server 300, comprising:
(i) receiving at the server 300 a first request 340 for a first image data file 310 over a network from a first client 350 using the TCP connection;
(ii) sending from the server 300 to the first client 350 a first response to the first request 340 and embedding a first timestamp 320 at a first time (t₁) into the first response;
(iii) receiving at the server 300 returned from the first client 355 at a second time (t₂) the first response containing the first timestamp 320;
(iv) determining a first difference (d₁) given by t₂ less t₁;
(v) receiving at the server 300 a second request for a second image data file over the network from a second client using the TCP connection;
(vi) entering one or both the first request 340 and the second request in a transfer queue 360, where the transfer queue 360 holds multiple data packets 310 queued for transfer;
(vii) receiving at the server 300 a third request 340 from the first client 350 for extra packets 330;
(viii) sending from the server 300 to the first client 350 a second response to the third request 340 and embedding a second timestamp 320 at a third time (t₃), where the third request 340 has precedence 305 over the second request in the transfer queue 360; and
(ix) receiving at the server 300 returned from the first client 355 the second response at a fourth time (t₄), where the second response contains the second timestamp 320;
(B) determining a second difference (d₂) given by t₄ less t₃;
(C) calculating an extra travel time (e₁) given by d₂ less d₁; and
(D) if e₁ is greater than a threshold eₘₐₓ, then reducing a send bandwidth (b_{send}) to bₗᵢₘᵢₜ, where bₗᵢₘᵢₜ is a bandwidth limit on the server 300.

2. The method of claim 1, further comprising:
(E) sending from the server 300 to the first client 350 a third response to the second request and embedding a third timestamp 320 at a fifth time (t₅); and
(i) receiving at the server 300 returned from the second client, the third response at a sixth time (t₆), where the third response contains the third timestamp 320;
(F) determining a third difference (d₃) given by to less t₅;
(G) calculating an extra travel time (e₂) given by d₃ less d_{2l ; and}
(H) if e₂ is greater than the threshold eₘₐₓ, then reducing the send bandwidth (b_{send}) to bₗᵢₘᵢₜ.

3. The method of claim 1, where bₗᵢₘᵢₜ is computed using a feedback scheme.

4. The method of claim 3, where the feedback scheme uses a pseudo code.

5. The method of claim 4, where the pseudo code includes an expression:
```
if (e > eₘₐₓ)
then
if (bytes in line > threshold)
then
  bₗᵢₘᵢₜ := max(Factor1 * bₑₛₜ, Factor2 * bₗᵢₘᵢₜ)
end
else
if (b_{read} > Factor3 * bₗᵢₘᵢₜ)
then
  d := Factor4 * bₗᵢₘᵢₜ * (eₘₐₓ − e)/ eₘₐₓ
  bₗᵢₘᵢₜ := bₗᵢₘᵢₜ + d
end;
```
where eₘₐₓ is a threshold delay, ‘bytes in line’ is a number of bytes in a line, ‘threshold’ is a line threshold, bₑₛₜ is based on a plurality of measurements of b_{read}, b_{read} is given by C/T, C is an amount of data bits of information that was read in a first time elapsed between a last two timestamp messages (cᵢ, cᵢ₋₁) and T is a second time elapsed between t₄ and t₂, where T=t₄−t₂+e₁, and Factor1, Factor2, Factor3 and Factor4 are factors which enforce conditions specified by the pseudo code.

6. The method of claim 1, further comprising a message-based protocol that is transported via the TCP connection.

7. The method of claim 6, where the first timestamp is sent using the message-based protocol.

8. The method of claim 1, where a server clock and a client clock are not synchronized.

9. The method of claim 1, further comprising where b_{send} is limited when e₁ is greater than approximately 40 msec.

10. The method of claim 1, further comprising where b_{send} is limited when e₁ is greater than approximately 50 msec.

11. A method of increasing responsiveness of a server operating a TCP connection (Transmission Control Protocol connection) comprising:
A) opening the TCP connection to receive and send TCP data packets at the server 300, comprising:
(i) receiving at the server 300 a first request for a first image data file 310 over a network from a first client 350 using the TCP connection;
(ii) sending from the server 300 to the first client 350 a first response to the first request and embedding a first timestamp 320 at a first time (t₁) into the first response;
(iii) receiving at the server 300 returned from the first client 355 at a second time (t₂), the first response containing the first timestamp 320;
(iv) determining a first difference (d₁) given by t₂ less t₁;
(v) receiving at the server 300 one or more other requests over the network from one or more other clients using the TCP connection, where the one or more other requests are for one or more image data files;
(vi) entering the first request and the one or more other requests in a transfer queue 360 at the server 300, where the transfer queue 360 holds the first request and the one or more other requests comprising multiple data packets 310 queued for transfer; and
(vii) receiving at the server 300 a second request 340 from the first client 350 for extra packets 330, where the second request 340 has precedence 305 over the one or more other requests;
(viii) sending from the server 300 to the first client 350 a second response to the second request 340 and embedding a second timestamp 320 at a third time (t₃); and
(ix) receiving at the server 300 returned from the first client 355 the second response at a fourth time (t₄), where the second response contains the second timestamp 320;
(B) determining a second difference (d₂) given by t₄ less t₃;
(C) calculating an extra travel time (e₁) given by d₂ less d₁; and
(D) if e₁ is greater than a threshold eₘₐₓ, then reducing a send bandwidth (b_{send}) to bₗᵢₘᵢₜ, where bₗᵢₘᵢₜ is a bandwidth limit on the server 300.

12. The method of claim 11, further comprising:
(E) sending from the server 300 to a second client of the one or more other clients a third response to a third request of the one or more other requests and embedding a third timestamp 320 at a fifth time (t₅); and
(i) receiving at the server 300 returned from the second client, the third response at a sixth time (t₆), where the third response contains the third timestamp 320;
(F) determining a third difference (d₃) given by t₆ less t₅;
(G) calculating an extra travel time (e₂) given by d₃ less d₂; and
(H) if e₂ is greater than the threshold eₘₐₓ, then reducing the send bandwidth (b_{send}) to bₗᵢₘᵢₜ.

13. The method of claim 11, where bₗᵢₘᵢₜ is computed using a feedback scheme.

14. The method of claim 13, where the feedback scheme uses a pseudo code.

15. The method of claim 14, where the pseudo code includes an expression:
```
if (e > eₘₐₓ)
then
if (bytes in line > threshold)
then
  bₗᵢₘᵢₜ := max(Factor1 * bₑₛₜ, Factor2 * bₗᵢₘᵢₜ)
end
else
if (b_{read} > Factor3 * bₗᵢₘᵢₜ)
then
  d := Factor4 * bₗᵢₘᵢₜ * (eₘₐₓ − e)/ eₘₐₓ
  bₗᵢₘᵢₜ := bₗᵢₘᵢₜ + d
end;
```
where eₘₐₓ is a threshold delay, ‘bytes in line’ is a number of bytes in a line, ‘threshold’ is a line threshold, bₑₛₜ is based on a plurality of measurements of b_{read}, b_{read} is given by C/T, C is an amount of data bits of information that was read in a first time elapsed between a last two timestamp messages (cᵢ, cᵢ₋₁) and T is a second time elapsed between t₄ and t₂, where T=t₄−t₂+e₁, and Factor1, Factor2, Factor3 and Factor4 are factors which enforce conditions specified by the pseudo code.

16. The method of claim 11, further comprising a message-based protocol that is transported via the TCP connection.

17. The method of claim 16, where the first timestamp is sent using the message-based protocol.

18. The method of claim 11, where a server clock and a client clock are not synchronized.

19. The method of claim 11, further comprising where b_{send} is limited when e₁ is greater than approximately 40 msec.

20. The method of claim 11, further comprising where b_{send} is limited when e₁ is greater than approximately 50 msec.
